(19) United States
(12) Patent Application Publication
(10) Pub. No.: US 2008/0227627 A1
(43) Pub. Date: Sep. 18, 2008

(54) Catalyst For the Treatment of Exhaust Gases and Processes For Producing the Same

(76) Inventors: Wolfgang Strehlau, Liederbach im Taunus (DE); Olga Gerlach, Ludwigshafen (DE); Juergen Maier, Mannheim (DE); Tamara Gabriel, Bruchsal (DE)

Correspondence Address: PATENT GROUP 2N;JONES DAY, NORTH POINT, 901 LAKESIDE AVENUE, CLEVELAND, OH, 44114, US

(21) Appl. No.: 11/913,868

(22) PCT Filed: May 12, 2006
(86) PCT No.: PCT/EP06/04499

§ 371 Date: May 29, 2008

(30) Foreign Application Priority Data
May 13, 2005 (EP) 05010515.4

(51) Int. Cl. B01J 23/44; B01J 29/04; B01J 23/10; B01J 23/62; B01J 23/63; B01J 21/06; B01J 21/02

(52) U.S. Cl. 502/61; 502/74; 502/66; 502/73

(57) ABSTRACT

Catalyst characterized in that it contains a composition comprising palladium, tin oxide and a carrier oxide and optionally a promoter and a zeolite which is doped with a dopant, processes for producing the same, its use for the removal of harmful substances from lean combustion engines and exhaust airs as well as methods for the removal of harmful substances from exhaust gases from lean combustion engines by using said catalysts by oxidizing carbon monoxide and hydrocarbons and simultaneously removing soot particulate by oxidation.

The present invention relates to a zeolite catalyst for the simultaneous removal of carbon monoxide and hydrocarbons from oxygen-rich exhaust gases, for example from the exhaust gases of diesel engines, lean Otto engines and stationary sources. The catalyst contains a composition comprising palladium, tin oxide and a carrier oxide and a zeolite doped with a dopant. Also, promoters and other non doped zeolites can be contained. The invention also relates to a process for the manufacture of the catalyst as well as to a process for the purification of exhaust gases by using the novel catalyst. The catalyst has a high conversion performance for carbon monoxide and hydrocarbons, a high thermal stability and a good sulfur resistance.

The important harmful substances from the exhaust gas of diesel engines are carbon monoxide (CO), unburned hydrocarbons (HC) such as paraffins, olefins, aldehydes, aromatic compounds, as well as nitric oxides (NOₓ), sulfur dioxide (SO₂) and sooty particles which contain carbon both in the solid form and in the form of the so-called “volatile organic fraction” (VOF). Further, diesel exhaust gas also contains oxygen in a concentration which is, dependent on the working point, around 1.5 to 15%.

The harmful substances which are emitted from lean Otto engines, for example from Otto engines that directly inject, consist substantially of CO, HC, NOₓ, and SO₂. Compared to CO and HC, the oxygen is present in a stoichiometrical surplus.

In the following, diesel engines and lean Otto engines are termed as “lean combustion engines”.

Both industrial exhaust gases and exhaust gases from domestic fuel also can contain unburned hydrocarbons and carbon monoxide.

The term “oxygen-rich exhaust gas” encompasses an exhaust gas, in which oxygen is present in a stoichiometrical surplus compared to the oxidizable harmful substances such as CO and HC.

Oxidation catalysts are employed for the removal of harmful substances from said exhaust gases. Said catalysts function to remove both carbon monoxide and hydrocarbons by oxidation, in which, in the ideal case, water and carbon dioxide are generated. Additionally, also soot can be removed by oxidation, in which also water and carbon dioxide are formed.

As a rule, the technically employed catalysts contain platinum as the active component. The advantages and drawbacks of said catalysts are briefly discussed in the following.

EP 1 129 764 A1 discloses an oxidation catalyst which contains at least one zeolite and additionally one of the carrier oxides aluminum oxide, silicon oxide, titanium oxide and aluminum silicate, and one of the noble metals Pt, Pd, Rh, Ir, Au and Ag, whereby the average particle size of the noble metals is between 1 and 6 μm. Further, the embodiments exclusively pertain to catalysts having platinum as the only noble metal.

U.S. Pat. No. 6,132,694 discloses a catalyst for the oxidation of volatile hydrocarbons which consists of a noble metal such as Pt, Pd, Au, Ag and Rh, and a metal oxide having more than one stable oxidation state, and which includes at least tin oxide. The metal oxide can be doped with small amounts of oxides of the transition metals. Other oxides are not mentioned. The catalyst is produced in a manner that preferably a monolithic body is loaded with several layers of tin oxide. Then, the noble metal is applied onto the tin oxide. According to the examples, particularly good results are obtained if the noble metal is platinum and the oxide having more than one stable oxidation state is tin oxide. The use of a carrier oxide is not planned.

Besides the oxidation of CO and HC, also the formation of NO₂ from NO and oxygen is promoted. Dependent on the total functionality of the oxidation catalyst, this can be an advantage or a drawback.

In conjunction with soot filters, the formation of NO₂ at the diesel oxidation catalyst may be desired, because the NO₂ contributes to the degradation of soot, i.e. contributes to the oxidation thereof to carbon dioxide and water. Such a combination of diesel oxidation catalyst and soot filter is also termed as CRT system (continuously regenerating trap) and, for example, is disclosed in the patents EP 835 684 and U.S. Pat. No. 6,516,611.

Without the use of soot filters in the exhaust gas line, the formation of NO₂ is undesired because NO₂ being emitted yields a strongly unpleasant odor.

Because of the chemical and physical properties of platinum, the platinum-containing catalysts have considerable drawbacks after highly thermal stress.

The exhaust gas temperatures of effective diesel engines which frequently are provided with turbo chargers, predominantly are run in a temperature range between 100 and 350° C., whereas regulations are given for the operation points of motor vehicles by the NED cycles (new European driving cycle). During the operation under partial load, the exhaust gas temperatures are in the range between 120 and 250° C. During the operation under full load, the temperatures reach as a maximum 650 to 700° C. On one hand, oxidation catalysts with low light-off temperatures (T₅₀ values) are required, and, on the other hand, a highly thermal stability is required in order to avoid a drastic activation loss during the operation under full load. Furthermore, it has to be noted that unburned hydrocarbons accumulate on the catalyst and can ignite there, so that local catalyst temperatures can be far beyond the temperature of 700° C. Temperature peaks up to 1000° C. can be achieved. Said temperature peaks can lead to a damage of the oxidation catalysts. Then, particularly in the low temperature range, no significant conversion of harmful substances is achieved by oxidation.

Typically, the concentrations of hydrocarbons in the exhaust gases of diesel engines are in a range of from 100-2,000 ppm, whereby said specification relates to C₁. A more detailed specification can be taken, for example, from the following review: Grigorius C. Koltsakis, Anastasios M. Stamatelos in Prog. Energy Combust. Sci. Vol. 23, pp. 1-39 (1997) Elsevier Science Ltd.

EP 0 781 592 B1 claims a purification method for a nitrogen oxide-containing exhaust gas using reduction that is carried out in the presence of a reducing agent. Here, the reducing agent can be a hydrocarbon or also an oxygen-containing organic compound. The catalyst being employed for the NOₓ-reduction method has the components aluminum oxide and tin in conjunction with metal species which can consist from the group of palladium, rhodium, ruthenium or indium. In the method that is described in the EP 0 781 592 B1, the so-called HC-SCR-properties of the catalyst are of central importance. The method relates to the treatment of exhaust gases having a content of hydrocarbons which substantially is higher than the hydrocarbon content than relating to a typical diesel exhaust gas.

Further, different soot filters were developed for the reduction of the particle emission from the diesel exhaust gas which, for example, are described in the patent application WO 02/26379 A1 and in U.S. Pat. No. 6,516,611 B1. During the combustion of the soot which accumulates on the particulate filters, carbon monoxide can be released which, by means of catalytically active coatings for soot filters, can be converted to carbon dioxide. Appropriate coatings can also be termed as oxidation catalysts. For the conversion of the soot into harmless CO₂ and water, the accumulated soot can be burned up in intervals, in which the necessary temperature for the burn-up of the soot can be produced for example by engine-internal methods. The burn-up of the soot, however, is associated with a high release of heat which can lead to a deactivation of the platinum-containing oxidation catalysts which are applied on the filters.

Therefore, for the compensation of thermal damages, platinum-containing oxidation catalysts for exhaust gases from diesel passenger cars are mostly provided with high quantities of platinum. Said quantities are typically in the range of from 2.1-4.6 g/l (60-130 g/ft³). For example, up to 9 g platinum are used for a 2 liter catalyst. The use of high quantities of platinum is an essential expense factor in the treatment of exhaust gases of diesel vehicles. The reduction of the platinum portion in the catalyst is of great economical interest.

In conjunction with the introduction of diesel particulate filters, besides the low light-off temperature and the required high thermal stability, further requirements for oxidation catalysts become apparent which are characterized subsequently.

For example, an oxidation catalyst can be installed in an upstream position of the diesel particulate filter. Then, it is possible to increase the concentration of hydrocarbons at the oxidation catalyst and to use the heat which is released when burning the hydrocarbons in order to initiate the combustion of the soot on the diesel particulate filter which is installed in the downstream position. Alternatively or also additionally, the diesel particulate filter itself can be coated with the oxidation catalyst. Thereby, the additional coating of the diesel particulate filter has the function to oxidize the carbon monoxide which is released during the combustion of the soot to carbon dioxide. In case of a high thermal stability and simultaneously high activity of such a coating, in some applications, the oxidation catalyst which additionally is installed in an upstream position, could be totally set aside. Both functionalities of oxidation catalysts that are discussed here in conjunction with the diesel particulate filters, require a high thermal stability of the catalysts whereby platinum-containing catalysts may have drawbacks as mentioned before.

Another problem for the purification of diesel exhaust gases relates to the presence of sulfur in the diesel fuel. Sulfur can be deposited onto the carrier oxide and can contribute to a deactivation of the oxidation catalysts by means of catalytic poisoning. Platinum-containing oxidation catalysts have an advantageously good resistance towards sulfur. In the known catalyst formulations, platinum has proved to be clearly superior over the other metals of the platinum group such as rhodium, palladium or iridium.

With regard to the treatment of exhaust of lean Otto engines, for example the directly injecting Otto engines, exhaust gas systems are used which either are composed of a three-way catalyst or an oxidation catalyst or a NOₓ-storage catalyst in a downstream position. The three-way catalyst respectively the oxidation catalyst particularly have the function to minimize the comparably high hydrocarbon emissions which arise in the homogeneous lean operation or in particular in the operation of a stratified charge engine. The thermal stability as well as an activity being as high as possible at low temperatures of appropriate catalysts which are mostly employed close to the engine, thereby have an outstanding importance.

The object of the invention was to develop a novel catalyst for the removal of harmful substances from exhaust gases of lean combustion engines and exhaust air which can oxidize CO and HC to CO₂ and water having a high activity at low temperatures, and which simultaneously has an improved thermal stability as well as a good sulfur resistance with respect to the catalysts of the prior art. Together with the improvement of the performance properties of the catalyst to be developed, a way should be found to decrease the manufacturing costs compared to the previously applied catalysts.

This object could be achieved with a catalyst characterized in that it contains
(i) a composition comprising palladium, tin oxide and a carrier oxide,
(ii) a zeolite, and
(iii) a dopant, the zeolite (ii) is doped with.

The catalyst is very stable in its thermal behavior and, at the same time, has a good sulfur resistance. After thermally aging at high temperature, the catalyst exhibits an improved efficiency for the CO and HC oxidation compared to the catalysts of the prior art.

Furthermore, platinum can be reduced in its quantity in a manner respectively the catalyst can be prepared without platinum that all in all a reduction of the material costs is possible compared to the catalysts of the prior art.

When preparing catalysts without platinum or when using only low quantities of platinum, the catalysts according to the invention practically have no tendency to the oxidation of NO to NO₂ by means of air oxygen, so that unpleasant odors can be minimized.

The dopant (iii) preferably is selected from the group of elements consisting of indium, gallium, tin, iron, rare earth elements, palladium, platinum, gold, and silver, and compounds thereof.

Thereby, the dopant can be on or in the zeolite (ii). Further, the zeolite can be doped partially or completely with the dopant.

Further, the composition (i) can contain a promoter which, preferably, is selected from the group consisting of indium, gallium, rare earth elements, alkali metals, earth alkali metals, platinum, gold, silver, iron, and compounds thereof.

The dopant which is present on or in the zeolite can be identical to the promoter. However, it is also possible that the dopant and the promoter are different.

One or more zeolites and carrier oxides as well as one or more dopants and promoters can be applied, respectively.

Preferably, the catalyst contains a composition which consists of palladium, tin oxide and a carrier oxide and optionally a promoter which, preferably, is one of the above defined elements or a compound thereof.

Preferred compounds of the above mentioned elements are the oxides and sub-oxides, the hydroxides and the carbonates.

For example, the term “palladium”, “platinum”, “gold”, and “silver” includes both the elements and compounds thereof, for example the oxides and sub-oxides.

The term “tin oxide”, “indium oxide”, “gallium oxide”, “iron oxide”, “alkali metal oxide”, “earth alkali metal oxide” and “rare earth element oxide” as well as the term “oxide of the indium, gallium, tin, the alkali metals, the earth alkali metal and the rare earth elements” include all possible oxides and sub-oxides as well as all possible hydroxides and carbonates.

The term “alkali metal oxide” comprises all oxides, sub-oxides, hydroxides and carbonates of the elements Li, Na, K, Rb and Cs.

The term “earth alkali metal oxide” comprises all oxides, sub-oxides, hydroxides and carbonates of the elements Mg, Ca, Sr and Ba.

The term “rare earth element oxide” comprises all oxides, sub-oxides, hydroxides and carbonates of the elements La, Ce, Pr, Nd, Pm, Sm, Eu, Gd, Tb, Dy, Ho, Er, Tm, Yb, Lu, Y and Sc.

Further components in which the above mentioned elements can be present are, for example, phosphorous-containing compounds such as phosphates, or nitrogen-containing compounds such as nitrates, or sulfur-containing such as sulfates.

The term “dopant” preferably means the above-mentioned elements and the compounds thereof. In general, they have an effect which increases the activity of the catalyst. They can be applied onto the zeolite (ii) during the manufacturing process. However, it is also possible to employ zeolites in the manufacture of the catalysts which already contain the dopant.

Preferably, the term “promoter” has the meaning of the above-mentioned elements and the compounds thereof. In general, they have an effect which increases the activity of the catalyst. They are applied onto the composition (i) during the manufacture of the catalyst.

Preferably, a “carrier oxide” is an oxide which is thermally stable and which has a large surface. The term also includes a mixture of at least two different carrier oxides.

Preferably, such oxides have a BET surface of more than 10 m²/g. In particular preferred are oxides having a BET surface of more than 50 m²/g, more preferred having a BET surface in the range of from 60 to 350 m²/g.

Preferably, carrier oxides are used which still have a large BET surface after treatment at high temperature. Further preferred is also a carrier oxide having a low tendency for the binding of sulfur oxides (SOₓ).

A silicon-containing or aluminum-containing carrier oxide is a carrier oxide which particularly contains silicon oxide, aluminum oxide, silicon/aluminum mixed oxide, aluminum silicate, kaolin, modified kaolin, or mixtures thereof.

Furthermore, a silicon dioxide can be applied which is pyrogenic or which was produced by precipitation of silicic acid.

Preferably, also pyrogenic aluminum oxide, α-aluminum oxide, δ-aluminum oxide, theta-aluminum oxide and γ-aluminum oxide can be applied.

Furthermore, aluminum oxides can be used which are doped with silicon oxide, with oxides of the earth alkali elements or with oxides of the rare earth elements.

The term “modified kaolins” means kaolins in which a part of the Al₂O₃ which is contained in the structure was unhinged by a thermal treatment and a subsequent treatment with acid. The kaolins which are treated in this manner have a higher BET-surface and a lower aluminum content compared to the starting material. Respectively modified kaolins can also be termed as aluminum silicates and are commercially available.

Some examples for carrier oxides which are suitable for the invention, however the invention is not limited to, are the following commercially available oxides:

Siralox 5/320 (Company Sasol), Siralox 10/320 (Company Sasol), Siralox 5/170 (Company Sasol), Puralox SCFa 140 (Company Sasol), Puralox SCFa 140 L3 (Company Sasol), F (Company Dorfner), F50 (Company Dorfner), F80 (Company Dorfner), F+5/24 (Company Dorfner), F+5/48 (Company Dorfner), F-5/24 (Company Dorfner), F-5/48 (Company Dorfner), F+10/2 (Company Dorfner), F+20/2 (Company Dorfner), SIAL 35 (Company Dorfner), SIAL 25-H (Company Dorfner), Alumina C (Company Degussa), SA 3*77 (Company Norton), SA 5262 (Company Norton), SA 6176 (Company Norton), Alumina HiQR10 (Company Alcoa), Alumina HiQR30 (Company Alcoa), Korund (Company Alcoa), MI307 (Company Grace Davison), MI407 (Company Grace Davison), MI286 (Company Grace Davison), MI386 (Company Grace Davison), MI396 (Company Grace Davison), MI486 (Company Grace Davison), Sident 9 (Company Degussa), Sipernat C 600 (Company Degussa), Sipernat 160 (Company Degussa), Ultrasil 360 (Company Degussa), Ultrasil VN 2 GR (Company Degussa), Ultrasil 7000 GR (Company Degussa), Kieselsäure 22 (Company Degussa), Aerosil 150 (Company Degussa), Aerosil 300 (Company Degussa), calcined Hydrotalzit Pural MG70 (Sasol).

Zeolites are known compounds and are partially commercially available.

In the scope of the present invention, it is possible to employ only one zeolite or only one zeolite modification or mixtures of different zeolites or different zeolite modifications. Thereby, the term modification comprises the zeolite type as well as the specific chemical composition, for example the Si/Al ratio.

Mostly, as the starting material, the zeolite is present in the sodium form, ammonium form or H form. Furthermore, it is also possible to convert the sodium, ammonium or H form into another ionic form by means of impregnation with metal salts and metal oxides or by means of ion exchange. As an example, the conversion of Na Y zeolite into RE zeolite (RE=rare earth element) by means of ion exchange in aqueous rare earth element chloride solution is mentioned. The ion exchange is a particular form of the doping of a zeolite. In the scope of the present invention, the doping of the zeolite has not only to be understood as an ion exchange, but in general as the depositing of a dopant onto the zeolite or in the zeolite. Thereby, preferably, the dopant can be present as oxide, sub-oxide, carbonate, sulfate, nitrate, or in elemental form.

Also all doping methods of the prior art can be used such as ion exchange, impregnation, precipitation or deposition of the dopant from the gas phase.

If, for example, the zeolite has to contain iron, then the doping of the zeolites with iron can be carried out in a manner that a water soluble iron compound, such as in the form of aqueous iron nitrate, is contacted with the zeolite. After the drying and optionally calcining, a zeolite is provided which is doped with iron. If, for example, the zeolite is to be doped with gold and iron, then a water soluble gold compound, such as HAuCl₄, can be admixed to the solution of the iron nitrate, so that the gold compound and the iron compound can simultaneously be impregnated onto the zeolite.

In predominantly using silicon-containing zeolites, it should be considered that the total amount of sodium in the catalyst does not essentially increase, because otherwise the properties may be negatively affected.

Particularly well suited zeolites are Y zeolite, DAY zeolite (dealuminated Y zeolite), USY zeolite (ultrastabilized Y zeolite), ZSM-5, ZSM-11, ZSM-20, silicalite, ferrierite, mordenite and β-zeolite.

The zeolites can also be hydrothermally treated.

Particularly suitable are also hydrothermally stable zeolites having a silicon/aluminum ratio of >8, whereby higher Si/Al ratios are preferred.

Examples for zeolites that are usable for the invention, however the present invention is not limited to, are: Mordenit HSZ@-900 (Company Tosoh), Ferrierit HSZ@-700 (Company Tosoh), HSZ@-900 (Tosoh), USY HSZ@-300 (Company Tosoh), DAY Wessalith HY25/5 (Company Degussa), ZSM-5 SiO₂/Al₂O₃ 25-30 (Company Grace Davison), ZSM-5 SiO₂/Al₂O₃ 50-55 (Company Grace Davison), β-Zeolith HBEA-25 (Company Süd-Chemie), HBEA-150 (Company Süd-Chemie), Zeocat PB/H (Company Zeochem).

It is also possible to apply several zeolites. Preferably, then these zeolites differ in that they have different pore radii or different Si/Al amount proportions or different pore radii and different Si/Al amount proportions.

The admixture of a zeolite for the formulation of a diesel oxidation catalyst is already known from the EP 0 800 856. Zeolites have the capability to adsorb hydrocarbons at low exhaust temperatures and to desorb said hydrocarbons as soon as the light-off temperature of the catalyst is reached or is exceeded.

As disclosed in the EP 1 129 764 A1, the effectiveness of the zeolites can also be based on the effect to “crack” the long-chain hydrocarbons which exist in the exhaust gas, that is to decompose them into smaller fractions which then can be easier oxidized by the noble metal.

In the EP 525 761 B1 a catalytically active material is claimed which consists of a fiber material which is coated with a zeolite, whereby the zeolite is a carrier of gold- and iron-containing species. For its catalytic activity, the material is used for the deodorizing of exhaust airs in the sanitary field.

The particularly high activity and stability of the catalyst emerges from the particular properties of the palladium/tin oxide/carrier oxide as well as from the particular type of the zeolite and the dopant respectively the doping of the zeolite.

Furthermore, the specific weight proportions of all zeolites, oxides and elements including the dopants and promoters—which are present in the catalyst, have importance.

In a particular embodiment, the mixture of at least two different zeolite types is preferred. For example, it can be reasonable to employ a zeolite having small pores up to medium size pores together with a zeolite having medium size pores up to large pores in order to optimally adsorb both small and large hydrocarbon molecules and to oxidize those to CO₂ and H₂O.

Furthermore, the admixture of zeolites having low polarity and slightly increased polarity is preferred in order to adsorb and to activate both polar and nonpolar hydrocarbons. In this manner, the polarity can not only be influenced by the zeolite type, but also by the Si/Al ratio. As a rule, with increasing aluminum content, the number of acidic centers of a zeolite increases and thus the polarity thereof. In addition, as a rule, with increasing aluminum content more dopant can be inserted by means of ion exchange in a cationic form into the zeolite.

In particular, it has proved of value to deposit a “non noble” dopant together with a “noble” dopant onto the zeolite or at least onto a part of the zeolite which was inserted into the catalyst because in this manner both a good adsorption of the hydrocarbons and a good oxidation of the hydrocarbons is achieved.

The term “noble” dopant means oxides and the metals of the platinum, palladium, gold and silver.

For example, the combinations indium/palladium and iron/platinum are effective.

An essential feature of the palladium/tin oxide/carrier oxide composition is that the tin oxide which is deposited on the carrier oxide has a roentgenographically amorphous form or a nanoparticular form.

Surprisingly, the roentgenographically amorphous form respectively the nanoparticular form of the tin oxide that is deposited onto the carrier oxide is maintained also at a high load of the carrier oxide with tin.

Thereby, the term “high load” relates to a content of tin to carrier oxide of approximately of from 20 to 30% by weight (based on the element tin).

Palladium in combination with the tin oxide is also present in a roentgenographically amorphous form or a nanoparticular form on the carrier oxide which, preferably, contains aluminum or silicon.

The term “roentgenographically amorphous” has the meaning that by means of wide-angle X-ray scattering analysis no analyzable reflexes are obtained being characteristical for a substance. This statement applies at least to the experimental conditions which are disclosed in the experimental part of the description.

In general, particle sizes can be detected by means of the Scherrer equation from X-ray diffraction analysis:

Scherrer Equation:

D=(0,9*λ)/(B cos θ_{B})

Herein, “D” means the thickness of a crystallite, “λ” the wave length of the used X-ray, “B” the full width at half maximum of the respective reflex and θ_{B} the position thereof. The fresh catalysts, i.e. the catalysts, which are calcined at 500° C., have tin oxide particle sizes which are in the range of from about 1 to 100 nm when measured according to the Scherrer method, whereby the particle sizes of the tin oxide can depend on the used carrier oxide. In some cases even no reflexes of the tin oxide are visible, so that the tin oxide which is present on said catalysts, can be termed as “roentgenographically amorphous”. After aging at 700° C., no or only very little agglomeration of the tin oxide particle is detectable, what depends on the used carrier oxide. This outlines the very good durability of the catalysts according to the invention.

Furthermore, the composition (i) palladium/tin-oxide/carrier oxide can contain promoters which are selected from the oxides and elements of indium, gallium, the alkali metal elements, earth alkali metal elements, rare earth elements, iron, platinum, gold, or silver, and which can contribute to an increase of the activity of the catalyst. As a rule, the promoters are also in a homogeneous form in the palladium/tin oxide/carrier oxide composition (i).

As a rule, the choice of suitable promoters results from the specific application of the catalyst and, for example, depends on the concentrations of CO, HC and NOₓ in the exhaust gas of the considered engine.

The preferred embodiments a) to i) of the catalysts are also characterized in that
(a) palladium and tin oxide and optionally a promoter are mutually present in directly topographical proximity on the zeolite,
(b) the tin oxide is present on the carrier oxide in a roentgenographically amorphous form or a nanoparticular form,
(c) palladium together with the tin oxide are present on the carrier oxide in a roentgenographically amorphous form or a nanoparticular form,
(d) tin oxide and palladium are very homogeneously dispersed on the surface of the carrier oxide,
(e) the carrier oxide according to a) to d) contains aluminum and/or silicon,
(f) a hydrothermally stable zeolite having a silicon/aluminum ratio of >8 is employed,
(g) at least one part of the zeolite is doped with at least one dopant,
(h) preferably a mixture of at least two different zeolite types is employed.

The homogeneity of the dispersion of palladium, tin oxide and optionally the promoters on the carrier oxide can thereby be described that preferably
(1) palladium, tin oxide and the promoters—by consideration of the individual particles—each are dispersed in approximately constant concentrations across the particles of the carrier oxide, and
(2) the concentration ratios—by consideration of the individual particles—of tin oxide to carrier oxide as well as the concentration ratios of tin oxide to palladium are approximately constant on the surface of the particles of the carrier oxide.

Said dispersion also includes that the catalyst, for example, contains mixtures of at least two palladium-containing carrier oxides which each have different tin oxide and/or palladium concentrations. Further, said dispersion also includes that the catalyst to be applied on a honeycomb shaped body is manufactured according to the process of the gradient coating. In case of a gradient coating, a gradient—for example of the palladium, the promoters and optionally of further components such as silver—for example is adjusted across the length of the honeycomb body.

In this manner, at the location of the entrance of the exhaust gas of the combustion engine into the catalyst, a higher concentration of active material is to be provided in order to obtain an overall better degree of efficiency of the active material.

Preferably, the term “gradient coating” relates to a gradient in the chemical composition.

For the application, the catalyst preferably is employed as powder, granulate, extrudate, shaped body, or as coated honeycomb body.

In a preferred embodiment, the catalyst is present in the form of a coated shaped body, preferably as coated honeycomb body, wherein it is structured in the form of a double layer.

Preferably the catalyst is present in the form of a coated shaped body, wherein a layer of the carrier oxide from the composition (i) is applied on the shaped body, and onto said layer another layer is applied which contains the zeolite (ii) which is doped with the dopant (iii).

In this embodiment, the double layer contains a zeolite-rich layer and a zeolite-poor layer.

The zeolite-poor layer is the lower layer, that is it is the layer which is directly on the shaped body, and the zeolite-rich layer is the upper layer.

The lower zeolite-poor layer contains the composition (i). Preferably, said composition can contain up to 20% by weight (based on the total amount of the layer) of zeolite (ii) which also can be doped with the dopant (iii). Particularly preferred is an amount of less than 10% by weight zeolite (ii).

Preferably, the upper zeolite-rich layer contains of from 60% to 100% by weight (based on the total amount of the layer) zeolite (ii), which is doped with the dopant (iii). Particularly preferred is an amount of from 80% to 100% by weight zeolite. Said layer can also contain other non doped zeolites, oxidic binders and carrier oxides. Thereby, preferably, the carrier oxides of the composition (i) are employed.

In another preferred embodiment, the palladium/tin-oxide/carrier oxide composition (i) and the zeolite (ii) are in a physical mixture on the carrier oxide, for example on a carrier oxide of the honeycomb type.

Preferably, the catalyst has a structure in which ducts exist which are formed as macropores which coexist with meso- and/or micropores.

The outstanding catalytical properties of the catalyst according to the invention are achieved by means of the following disclosed processes for the manufacture of the catalyst, by the relatively high load of the carrier oxide with promoter respectively by the selection of the weight proportions of the components which are contained in the catalyst, as well as by the use of zeolites having certain dopants.

The catalyst is produced by a process which is characterized in that it comprises the step (j) or (jj):
(j) contacting a tin compound, a palladium compound, a carrier oxide and optionally a promoter with a zeolite and a dopant,
(jj) contacting a tin compound, a palladium compound, a carrier oxide and optionally a promoter with a zeolite which is doped with a dopant.

The term “tin and palladium compounds” of the step (i) stands for all tin and palladium compounds which can be suspended in a liquid medium and/or are completely or at least partially soluble in said medium.

Also the dopant or optionally a co-employed promoter are employed in the form of compounds which can be suspended in a liquid medium and/or are completely or at least partially dissolvable in said medium.

Preferably, tin and palladium compounds and the dopant and optionally the promoters are employed which are completely or at least partially soluble in said liquid medium.

Preferably, the liquid medium is water.

Preferably, salts of tin, palladium, of the promoters and of the dopant are employed. For example, salts are the salts of inorganic acids, such as chlorides, bromides, cyanides, nitrates, oxalates, acetates, or tartrates. The use of soluble complex compounds is also possible. One example is gold dimethylacetonate.

Furthermore, the employed tin and palladium compounds as well as the promoters and the dopant can be subjected to a chemical treatment. For example, said compounds can be treated with acids as described below for the tin compounds. Also the addition of acids and complexing agents is possible. By means of said treatment, for example, said compounds can be converted into a particularly good solubility condition which is advantageous for the intended processing.

Preferably, the respective nitrate and acetate compounds are employed. For example, the nitrates of the rare earth elements are accessible in the technical scale by dissolving the carbonates thereof in nitric acid. The use of nitrates is particularly preferred if the compounds of the tin and the palladium are simultaneously applied with the compounds of the promoters onto the carrier oxide.

Preferably, tin oxalate or tin oxide being dissolved or suspended in water are applied as the tin compound, in which the solubility can be further increased by the addition of acids such as nitric acid.

For the manufacture of the catalysts, a process is preferred, where the starting compounds of the tin, palladium, the promoters and the dopant are contacted by means of the aqueous medium with the carrier oxide respectively the zeolite.

For the manufacture of the catalyst, a process is preferred where tin and palladium compounds are employed being free as possible from chloride, because a later release of chloride-containing compounds from the catalyst can lead to severe damages of the exhaust gas facilities.

“Contacting” in step (j) means that the compounds of the tin, of the palladium, and optionally of the promoters, of the zeolite and the dopant are applied onto the mutual carrier oxide in suspended or preferably dissolved form either simultaneously, in admixtures, or sequentially. For example, at first, the compounds of the tin can be applied onto the carrier oxide, whereas the compounds of the palladium and of the promoters are prepared in a mutual solution, and are contacted in a sub-sequent step with the carrier oxide. Also, for example, it is possible to prepare separate solutions of the promoters and of the palladium compounds and to contact said solutions sequentially with the carrier oxide. As a rule, after each contacting, a drying step is carried out.

“Contacting” in step (jj) means that compounds of the tin, of the palladium, and optionally of the promoters, and of the zeolite which is doped with the dopant, are applied in suspended or preferably dissolved form either simultaneously, in admixtures, or sequentially onto the mutual carrier oxide. Thereby, prior to the application, the dopant is deposited in suspended or preferably dissolved form onto or in the zeolite. For example, the zeolite can be impregnated with an aqueous solution of the compounds of the respective dopant. After drying and calcining the impregnated zeolite, the dopant remains on or in the zeolite. As a rule, then the doped zeolite can be processed in aqueous medium, for example in the form of an aqueous suspension, without re-dissolving the dopant.

After loading the carrier oxide and the zeolite with the compounds of the tin, the palladium, the promoters and the dopant, in dependence on the manufacturing method, at least one drying step and, as a rule, at least one calcining step follow. In the event of a spray calcination, such as described in the EP 0 957 064 B1, the drying step and the calcining step can practically be carried out in a single process step.

The mentioned reaction sequences can also be carried out with a zeolite which is doped with a dopant.

As a rule, after the application of all constituents of the catalyst onto the shaped body, said shaped body is dried and calcined.

Therefore, the process also includes the step (jjj):
(jjj) calcining.

Preferably, the calcining step is carried out at a temperature of from 200 to 1000° C., more preferred of from 300° C. to 900° C., in particular of from 400 to 800° C.

By means of the calcining step, the compounds of the tin, the promoters and the dopant are thermally fixed and converted into their catalytically active form.

By means of the calcining step, also the mechanical stability of the catalyst is increased.

The calcining step can be carried out in dry or humid air, in nitrogen, forming gas, or also in water vapour.

For the manufacture of the catalyst, all embodiments are preferred which generally have proved of value in the catalyst research, in particular “washcoat” and/or “honeycomb” and “powder or pellet” technologies. Exemplarily, the embodiments (α), (β), (γ), (δ), (ε), and (ζ) are discussed below.

(α) It is possible to proceed in a manner wherein the carrier oxide together with the zeolite is ground in an aqueous suspension to particle sizes of several micrometers, and is then applied onto a ceramic or metallic shaped body. For this, the shaped body is dunked into the carrier oxide/zeolite suspension, whereupon said shaped body is loaded with both the carrier oxide and the zeolite. After the thermal treatment such as drying or calcining, a shaped body is obtained being coated with the carrier oxide and the zeolite. Then, the coated shaped body is impregnated with the compounds of the tin, the palladium, the dopant and optionally the promoters, whereby the zeolite and the carrier oxide are loaded. Dependent on the solubility of the compounds among each other, and dependent on the preferred process guidance, the before mentioned compounds can be applied individually or in suitable mixtures. As a rule, after each impregnation step each a drying step is carried out. Impregnation steps and drying steps are repeated as often until all compounds are impregnated onto the carrier, and until the desired load amounts are achieved. After the termination of the impregnation and drying steps, the calcining step is performed.

(β) However, it is also possible to add the dissolved compounds of the tin, the palladium, the dopant, and optionally the promoters to the ground carrier oxide/zeolite suspension, and then to dunk the shaped body into the suspension, to load, i.e. to impregnate, to dry and to calcine. The process can be repeated as often until the desired load amount is achieved.

(γ) Also, it is possible firstly to grind the carrier oxide in aqueous suspension to particle sizes having few micrometers, and then to apply onto a ceramic or metallic shaped body. For this, the shaped body is dunked into the carrier oxide suspension, whereupon it is loaded with the carrier oxide, that is it is impregnated. After the thermal treatment such as drying or calcining, a shaped body is obtained, which is coated with the carrier oxide. Now, the zeolite can be applied onto the carrier in a manner that it is firstly provided with additional, ground carrier oxide in aqueous suspension, and then is applied onto the shaped body by a new dunking step. The addition of carrier oxide into the suspension of the zeolite serves for the improvement of the adhesion properties of the zeolite on the carrier. The carrier is again dried or calcined. Now, on the carrier body, carrier oxide and zeolite/carrier oxide are present in the form of two layers, that is a zeolite-poor and a zeolite-rich layer. Fundamentally, the carrier oxides of the zeolite-poor and the zeolite-rich layer can differ with respect to the physical/chemical properties.

Then, the coated shaped body is impregnated by dunking with the compounds of the tin, the palladium, the dopant, and optionally the promoters. Dependent on the solubility and the preferred process management, the before-mentioned compounds can be applied individually or in suitable admixtures. After each impregnation step a drying step is carried out, respectively. The process can be repeated as often until the desired load amount is achieved. Alternatively, firstly also the carrier oxide can be applied onto the carrier, then the impregnation with the tin, palladium, and optionally promoter compounds can be carried out, followed by a drying step. Subsequently, a zeolite-rich layer can be applied by soaking the shaped body in a zeolite-containing suspension. After the drying and an impregnation with at least one compound of a dopant, another drying step and calcining step are carried out.

(δ) Further, it is also possible to firstly impregnate a mixture of powdery carrier oxide and zeolite with the compounds of the tin, the palladium, the dopant, and optionally the promoters, whereby the used total volume of the impregnation solution respectively the impregnation solutions is below the maximum take-up capacity of the liquid of the carrier oxide. In this manner, an impregnated carrier oxide/zeolite powder can be gained which appears to be dry which, in a subsequent step, is dried and calcined. The composition which is gained in this manner, then can be provided in water and can be ground. Subsequently, the washcoat can be applied onto a shaped body.

(ε) However, it is also possible to add the compounds of the tin, the palladium and optionally the promoters to a carrier oxide suspension, then to filter off the solid, to dry it respectively to calcine it. Alternatively, the suspension containing the carrier oxide, the tin compounds and palladium compounds and optionally the promoter compounds can be spray-dried and can be calcined. In a separate approach, in a corresponding manner, the dopant can be applied onto the zeolite. Then, the palladium-containing and tin oxide-containing carrier oxide and the doped zeolite can be applied either in a mutual washcoat in the form of a single layer onto the carrier, or can be processed to two separate washcoats and can be applied sequentially onto a carrier, that is in the form of a double layer. The coating of the carrier is followed by a drying step and a calcining step. For example, however, the catalyst can also be obtained in powder form or can be processed to an extrudate.

(ζ) Furthermore, it is possible to provide the carrier oxide in an aqueous medium, and then to add the compounds of the tin and optionally the promoters. Subsequently, the suspension can be spray-dried and can be calcined or calcined by spraying. In a separate attempt, the zeolite can be impregnated with dopants or can be ion-exchanged and, for example, can be processed to a dry powder by spray-drying or other common drying methods and calcining methods. Now, the tin-containing carrier oxide and the doped zeolite can be provided in aqueous medium, and can be processed by grinding to a washcoat. Subsequently, the washcoat can be applied onto a shaped body. After the drying step, the palladium compound, and optionally further promoter compounds can be impregnated onto the shaped body. Another drying step as well as a calcining step will follow.

It is also possible to process the tin-containing carrier oxide and the doped zeolite separately to washcoats, so that after the sequential dunking of the shaped body into the tin-containing suspension of the carrier oxide and subsequently in the suspension of the zeolite a double layer structure can be verified.

Fundamentally, for the manufacture of the catalyst also other sequences of known process steps are realizable. However, particularly, those process pathes are favored in which the deposition of the tin oxide and optionally of the promoters onto the carrier oxide as well as of the dopant onto the zeolite is successful as targeted as possible.

For the homogeneous dispersion of the compounds onto the carrier oxide and the zeolite, besides the above-described methods, that is the soaking of the carrier oxide respectively the zeolite with metal salt solutions, impregnation of the carrier materials with metal salt solutions, adsorption of metal salts from liquids, also the spray impregnation of solutions, the application by precipitation from solutions or the deposition from solutions can be used.

Also the application of the compounds of the tin, the palladium, the dopant and optionally the promoters from a suspension is possible.

Besides the above-described necessary components of the catalyst, in the manufacture of the catalyst or for the treatment of said catalyst, also additives and/or admixtures can be added, such as oxides and mixed oxides as additives to the carrier material, binders, fillers, hydrocarbon adsorbers or other adsorbing materials, dopings for the increase of the temperature resistance as well as mixtures of at least two of the above-mentioned substances.

Said further components can be inserted into the washcoat in a water-soluble and/or a water-insoluble form prior to or after the coating step.

All known methods can be used for the load of the carrier oxide by contacting with the dissolved compounds of the promoters and the palladium as well as for the drying and calcining. Said methods depend on the selected process types, in particular therefrom whether the “washcoat” is applied at first onto a shaped body, or whether a powder process is selected. Said methods comprise processes such as “incipient wetness”, “dunking impregnation”, “spray impregnation”, “spray drying”, “spray calcination” and “rotary calcination”. For the load of the zeolite by contacting with a dissolved gold compound as well as for the drying and calcining, the before mentioned processes can also be used.

The confection of the catalyst can also be carried out according to the known methods, for example by means of extruding or by extrusion molding.

After the manufacture, the catalyst according to the invention is preferably provided as powder, pellets, extrudate, or as a shaped body such as a coated honeycomb body.

In the following, the chemical composition of the catalysts according to the invention is disclosed. The weight proportions in % are based on the elemental mass of tin, palladium, the promoters and the dopant, respectively. For the carrier oxides as well as for the zeolites, the weight proportions are based on the respective oxidic compounds.

Typical amounts of palladium of the catalyst according to the invention are about of from 1.06 g/L-2.1 g/L (30-60 g/ft³), however, dependent on the application, can deviate from said amounts. As is known to the skilled person, the units “g/L” respectively “g/ft³” relate in the event of carried catalysts to the elemental mass of the noble metal in relation to the carrier volume, for example to the volume of a honeycomb shaped body.

The catalyst is characterized by the following defined weight proportions of carrier oxide, zeolite, palladium, promoters and dopants. Thereby, the masses of the zeolite and the carrier oxide are based on their oxidic form, and the masses of the palladium, the promoters and the dopant are based on the elemental form.

The catalyst contains a total amount of from 3-50% by weight of tin oxide (calculated as element) based on the total amount of carrier oxide, wherein a total amount of from 5-30% by weight of tin oxide is preferred.

The catalyst contains a total amount of from 0.2-10% by weight of palladium (calculated as element) based on the total amount of carrier oxide, wherein a total amount of from 0.4-5% by weight of palladium is preferred.

The weight proportion of tin to palladium (calculated as elements) preferably is in a range of from 2:1 to 50:1, wherein a weight proportion in a range of from 4:1 to 30:1 is more preferred.

The weight proportion of tin to promoter (calculated as elements) preferably is in a range of from 100:1 to 0.1:1, wherein a weight proportion in a range of from 50:1 to 0.5:1 is more preferred. Still more preferred is a weight proportion in a range of from 30:1 to 1:1.

The total amount of zeolite based on the carrier oxide (calculated as oxides) preferably is of from 5-60% by weight. More preferred is a total amount of zeolite in a range of from 8-50% by weight. In particular preferred is a range of from 10-40% by weight.

The total amount of dopant (calculated as element) to zeolit (calculated as oxide) preferably is of from 0.001-10% by weight. More preferred is a total amount of dopant of from 0.1-8% by weight. In particular preferred is a range of from 0.5-5% by weight.

The invention also relates to the use of the catalyst for the removal of harmful substances from the exhaust gases of lean combustion engines and exhaust airs.

Furthermore, the present invention also relates to a process for the purification of exhaust gases of lean combustion engines and exhaust airs by using the above disclosed catalyst.

Preferably, said process for the purification of exhaust gases is carried out in a manner that said purification comprises the simultaneous oxidation of hydrocarbons and carbon monoxide as well as the removal of soot by oxidation.

The catalysts can also be run in combination with at least one other catalyst or particulate filter. Thereby, for example, the particulate filter can be coated with the catalyst.

The combination of the catalyst according to the invention with another catalyst comprises
(αα) a sequential arrangement of the different catalysts,
(ββ) a physical mixture of the different catalysts and the application onto a mutual shaped body, or
(γγ) an application of the different catalysts in the form of layers onto a mutual shaped body,
   as well as any combination thereof.

In a preferred embodiment, the particulate filter itself is coated with the oxidation catalyst.

In the following, the manufacture of exemplified catalysts is illustrated and the properties thereof are presented in comparison to the prior art. The fact that this is carried out at hand of concrete examples by specifying concrete values shall in no case be understood as limitation of the specifications which are made in the description and in the claims.

In the figures show

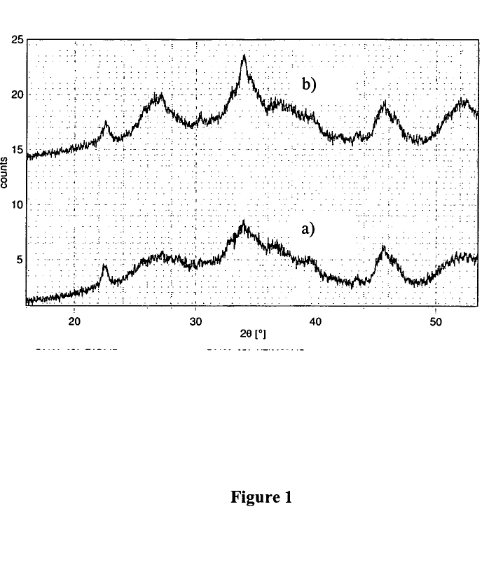

FIG. 1 the X-ray diffraction analysis of the following samples: a) B03 (fresh) and b) B03 (hydrothermally aged for 16 hours at 850° C.). The horizontal axis shows the 2-theta-scale in the unit degree, and the vertical axis shows the intensity of the X-ray in arbitrarily selected unit. [The roentgenographical experiments of the samples were carried out with a BRUKER AXS-X-Ray-Diffractometer (Co. Bruker) that was equipped with a GADDS surface detector. The exposure time per X-ray diffraction analysis was 100 min];

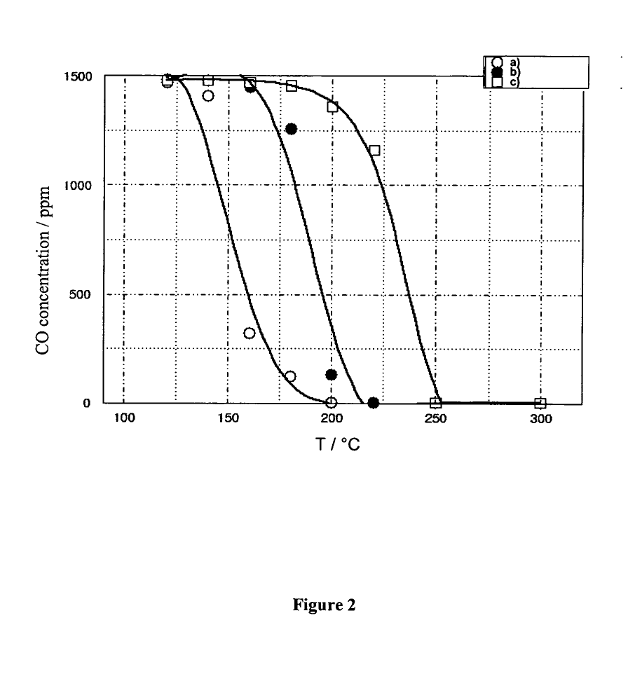

FIG. 2 the CO concentration as function of the reaction temperature at the catalyst samples after the different aging types: a) B02 hydrotheramlly aged at 850° C.; b) B05 thermally aged at 1050° C.; c) CE01 reference thermally aged at 950° C.;

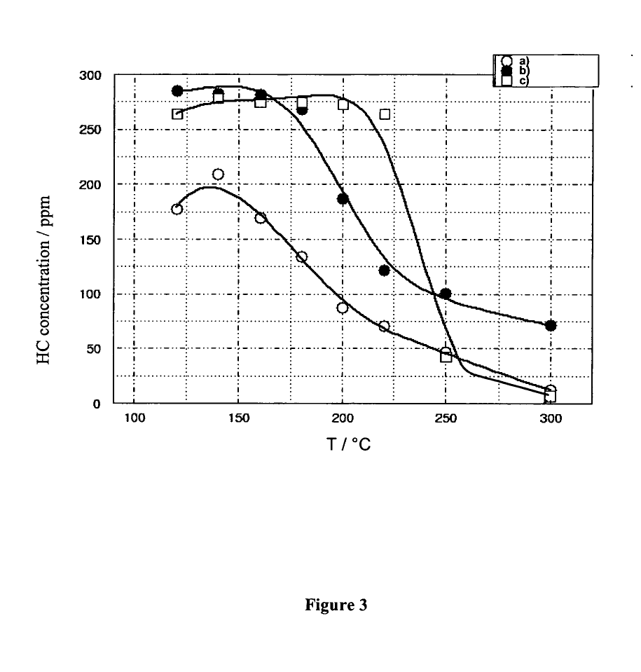

FIG. 3 the HC concentration as function of the reaction temperature at the catalyst samples after the different aging types: a) B02 hydrothermally aged at 850° C.; b) B05 thermally aged at 1050° C.; c) CE01 reference thermally aged at 950° C.;

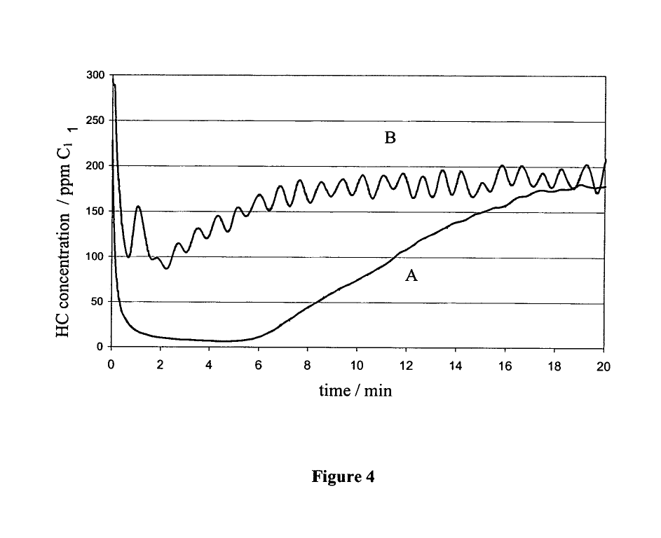

FIG. 4 the HC-concentration as function of the time at the catalysts A) B10 thermally aged at 700° C. and B) CE01 thermally aged at 700° C.

### MEASUREMENT OF THE ACTIVITY OF THE CATALYSTS

The activity measurements were carried out in a fully automated catalyst facility having 48 fixed bed reactors made from stainless steel (the inner diameter of an individual reaction chamber was 7 mm) which were run in parallel. The catalysts were tested under conditions being similar to diesel exhaust gas in a continuously operational mode with an oxygen surplus using the following conditions:

| | |
|---|---|
| temperature range: | 120-400° C. |
| exhaust gas composition: | 1500 vppm CO, 180 vppm C₁ (octane), 100 |
| | vppm C₁ (propene), 100 vppm NO, 10% O₂, |
| | 10% CO₂, 5% H₂O, balance - N₂. |
| GHSV: | 60 000 h⁻¹ |

The catalysts in the form of a honeycomb were mortared and were used as a bulk material for the measurements.

As reference catalyst (CE), a commercial honeycomb shaped oxidation catalyst for exhaust gases from diesel engines was utilized having 3.1 g/l (90 g/ft³) platinum which was also mortared and was also used as bulk material for the measurements.

The comparison measurements between the catalysts according to the invention and the reference catalyst were carried out on the basis of approximately the same catalyst volumes. The mass of the catalysts according to the invention being used for the measurements was clearly lower compared to the mass of the reference catalyst, because the catalysts according to the invention had a typical mass of noble metals between 30 and 60 g/ft³.

The determination of CO and CO₂ was carried out with ND-IR-analyzers of the company ABB (“Advance Optima” type). The determination of the hydrocarbon was carried out with a FID of the company ABB (“Advance Optima” type). O₂ was determined with a λ-sensor of the company Etas, whereas the determination of NO, NO₂ and NOₓ was carried out with an ultraviolet apparatus of company ABB (“Advance Optima” type).

For the assessment of the catalysts, the T₅₀ values (temperature, where 50% conversion is achieved) were used as criteria for the CO and HC oxidation as assessment criteria for the oxidation activity.

The T₅₀ values for the catalysts after the different aging processes (thermally aging, hydrothermally aging, sulfur aging) are summarized in the Tables 2 to 3.

### Measurement of the Adsorption of Hydrocarbons

The measurement of the storage behavior of the catalysts for the hydrocarbons was carried out with the above-described testing facility by using also the above-described gas mixture, whereby, however, as hydrocarbon solely octane was used. With regard to the course of the experiment, at first a reactor temperature of 110° C. was adjusted, and the catalyst to be measured was pre-conditioned in a flow of synthetic air. Then, at a predefined moment, the catalyst to be measured was applied with the octane-containing gas mixture. The HC concentration was measured as function of the time.

### Sulfur Aging

The term “sulfur aging (also sulfur tolerance or sulfur resistance)” describes the capability of an oxidation catalyst to oxidize CO and HC being contained in the exhaust gas to CO₂ and H₂O, also after the influence of sulfur oxides (SOₓ).

The sulfur aging was carried out in a 48-folded parallel reactor using the following conditions:

| | |
|---|---|
| temperature: | 350° C. |
| duration: | 24 hours |
| gas composition: | 150 vppm SO₂, 5% H₂O, balance - synthetic air |
| space rate: | 13000 h⁻¹ |

After the aging for 24 hours, the feeding of the SO₂ was terminated and the catalysts were cooled down in synthetic air.

### Thermally Aging

The thermally aging of the catalysts was carried out in air in a muffle furnace at a temperature of 700, 950 or 1050° C. in air. Thereby, the catalysts were kept for 10 hours at this temperature, and were then cooled down to room temperature.

### Hydrothermally Aging

The hydrothermally aging was carried out in a muffle furnace at a temperature of 850° C. in an air flow that contained water in an amount of 10%. In doing this, the catalysts were kept for 16 hours at this temperature, and were then cooled down to room temperature.

### EXAMPLES

### Example B01

For the manufacture of the catalyst B01, a mechanical mixture of 80% per weight alumina (Puralox SCFa 140) of the company Sasol and 20% by weight betazeolite (Zeocat PB/H) of the company Zeochem were suspended in deionized water and were ground in a mill (Dyno-Mill Type Multi Lab) of the company Willy A. Bachofen. The thereby resulting coating suspension had a solids content of 20% by weight. Said coating suspension had very good adhesion properties and was used without addition of further binders for the manufacture of the washcoat.

As catalyst carrier, a honeycomb-shaped core made of cordierite having 400 cpsi (channels per square inch) of the company NGK was used which, prior to the use, was cut to a dimension of 1 inch in diameter and 2 inches in length.

The core was coated by multiple dunking into the coating suspension having the alumina/zeolite washcoat, whereupon after each dunking step the ducts of the core were blown out in order to remove an excess of suspension. After each coating step, the core was dried in an air flow and finally calcined for 15 min in the air flow at 500° C. The washcoat load was 120 g/L. Said load represents the solid amount of the washcoat after calcining which was applied onto the shaped body.

The application of the tin, the palladium and the dopant onto the core which was coated with the washcoat took place in several steps.

In the first step, the washcoat-containing core was impregnated with an aqueous solution which contained tin oxalate, iron nitrate and nitric acid. For this, 4.1 ml of an aqueous, nitric acid-containing, 1.0 molar tin oxalate solution were mixed with 0.11 ml of a 1.0 molar iron nitrate solution, and were diluted with 0.9 ml water. The resulting solution was applied onto the coated core by dunking. The so impregnated core was then dried in the air flow and was calcined for 15 min at 500° C. in the air flow.

In the next step, the application of the gold compound took place. In this regard, the core was impregnated with 5 ml of an aqueous, 2.6×10⁻⁴ molar HAuCl₄ solution. Subsequently, the core was dried in the air flow.

Then the impregnation with a palladium compound was carried out. For this, the core was impregnated with 5 ml of an aqueous, 0.08 molar palladium nitrate solution, and was dried in the air flow.

Subsequently, the catalyst was calcined for 2 hours at 500° C. in a muffle furnace under air (termed as “fresh”).

The completed catalyst contained 96 g/L Puralox SCFa 140, 24 g/L Zeocat PB/H, 19 g/L tin, 0.24 g/L iron, 0.01 g/L gold, and 1.65 g/L palladium.

The completed catalyst was transferred into chips by carefully mortaring.

Two fractions of the chips were calcined for 10 hours at 950° C. and 1050° C. in air (termed as “thermally aged”).

Another fraction of the chips was calcined for 16 hours at 850° C. in air which contained 10% by volume water (termed as “hydrothermally aged”).

### Examples B02 to B03

The catalysts were manufactured analogously to example B01, whereupon a mechanical mixture of silica-alumina (Siralox 5/170) of the company Sasol, and Zeocat PB/H of the company Zeochem was used for the washcoat, and the load of the washcoat with tin, palladium and gold was varied. Furthermore, no iron was employed.

In Table 1, the compositions of the catalysts according to example B02 to B03 are presented based on weight in the unit g/L, whereby said specification relates to the oxidic form of the carrier oxide and of the zeolite and to the elemental form of the palladium, tin and gold.

### Examples B04 to B05

The catalysts were manufactured analogously to example B01, whereupon a mechanical mixture of silica-alumina (Siralox 5/170) of the company Sasol, and Zeocat PB/H of the company Zeochem. was used for the washcoat, and the load of the washcoat with tin, palladium, iron and gold was varied. Furthermore, the catalysts additionally contained the promoters gallium (B04) or indium (B05). The gallium and indium compounds were added to the nitric acid containing tin-oxalate/iron nitrate impregnation solution in the form of their nitrates.

In Table 1, the compositions of the catalysts according to example B04 and B05 are represented based on weight in the unit g/L, whereupon said specifications relate to the oxidic form of the carrier oxide and of the zeolite and to the elemental form of the palladium, the tin, the dopant and the promoters.

### Examples B06 and B07

The catalysts were manufactured analogously to example B01, whereupon the load of the catalyst components was varied, and silver (B06) or indium (B07) were used as further promoters respectively dopants. The silver and indium compounds were added in the form of their nitrates to the nitric acid-containing tin oxalate/iron nitrate impregnation solution.

In Table 1, the compositions of the catalysts according to example B06 and B07 are represented in the unit g/L based on weight, whereupon said specifications relate to the oxidic form of the carrier oxide and the zeolite and to the elemental form of the palladium, tin, the dopant and promoters.

### Example B08

The catalyst according to this example is structured in the form of a double layer.

For the manufacture of the first layer of the catalyst, an alumina (Puralox SCFa 140) of the company Sasol was suspended in deionized water, and was ground in a mill (Dyno-Mill Type Multi Lab) of the company Willy A. Bachofen. The thereby formed coating suspension had a solids content of 20%. Said coating suspension had very good adhesion properties and was employed without addition of further binders for the manufacture of the first layer of the washcoat.

As catalyst carrier, a honeycomb-shaped core of cordierite having 400 cpsi (channels per square inch) of the company NGK was used which, prior to the use, was cut to a dimension of 1 inch in diameter and 2 inch in length.

The core was coated by multiple dunking into the coating suspension with the alumina washcoat, whereupon after each dunking step the ducts of the core were blown out in order to remove an excess of the suspension. After each coating step, the core was dried in the air flow and subsequently was calcined for 15 min in the air flow at 500° C. The washcoat load was 124 g/L. Said load represents the solids content of the washcoat which was applied onto the shaped body after calcining.

Subsequently, the compounds of the palladium, tin and gallium were impregnated onto the coated core. For this, 4.3 ml of an aqueous, nitric acid-containing, 1.0 molar tin oxalate solution were mixed with 0.89 ml of an 1.0 molar gallium nitrate solution and 0.26 ml of a 1.0 molar palladium nitrate solution, and were diluted with 0.5 ml water. The resulting solution was applied onto the coated core by dunking. The so impregnated core was then dried in the air flow and was calcined for 15 min at 500° C. in the air flow.

The first layer of the catalyst contained 124 g/L Puralox SCFa, 20 g/L tin, 2.4 g/L gallium and 1.07 g/L palladium.

For the manufacture of the second layer of the catalyst, a zeolite (Zeocat PB/H) of the company Zeochem was suspended in deionized water and was ground in a mill (Dyno-Mill Type Multi Lab) of the company Willy A. Bachofen. The coating suspension had a solids content of 20% by weight. To 100 ml of said suspension, 1.2 ml of an aqueous 0.1 molar HAuCl₄ solution were added and were stirred for 15 min. Subsequently, 13.2 ml of an aqueous 0.1 molar palladium nitrate solution were added and were stirred for further 15 min. For the improvement of the adhesion properties of the zeolite-containing washcoat, 1.8 ml of a colloidal SiO₂ suspension (Ludox TMA, 34% SiO₂) of the company DuPont were added to the gold/palladium-containing zeolite suspension.

The core having the first layer was coated with the second layer by repeatedly dunking into the gold- and palladium-containing zeolite suspension. After each dunking step, the ducts of the core were blown out in order to remove an excess of zeolite suspension, and a drying in the air flow was carried out. The coating was dried in the air flow, and subsequently was calcined for 15 min in the air flow at 500° C. The loading of the second layer was 52 g/L. Said load represents the solids content of the zeolite-containing washcoat after calcining which was applied onto the shaped body.

The second layer of the catalyst contained 50 g/L Zeocat PB/H, 0.06 g/L gold and 0.35 g/L palladium.

Subsequently, the catalyst was calcined for 2 hours at 500° C. in the muffle furnace in air (termed as “fresh”).

The completed catalyst was transferred into chips by carefully mortaring.

Two fractions of the chips were additionally calcined for 10 hours each at 950° C. and 1050° C. in air (termed as “thermally aged”).

Another fraction of the chips was calcined for 16 hours at 850° C. in air which contained 10% by volume water (termed as “hydrothermally aged”).

### Example B09

The catalyst B09 was manufactured analogously to example B08, whereupon the load and the composition of the second layer were varied.

The second layer of the catalyst contained 25 g/L Zeocat PB/H, 0.01 g/L gold and 0.09 g/L palladium.

In Table 1, the compositions of the catalysts according to example B09 are represented based on weight in the unit g/L, whereupon said specifications relate to the oxidic form of the carrier oxide and to the zeolite and to the elemental form of the noble metals and the promoters.

### Example 10

The catalyst according to this example is structured in the form of a double layer.

For the manufacture of the first layer of the catalyst, an alumina (Puralox SCFa 140) of the company Sasol was suspended in deionized water and was ground in a mill (Dyno-Mill Type Multi Lab) of the company Willy A. Bachofen. The thereby produced coating suspension had a solids content of 20% by weight. Said coating suspension had very good adhesion properties and was employed without addition of further binders for the manufacture of the first layer of the washcoat.

As the catalyst carrier, a honeycomb-shaped core made from cordierite having 400 cpsi (channels per square inch) of the company NGK was used which, prior to the use, was cut to a dimension of 1 inch in diameter and 2 inch in length.

The core was coated with the alumina-containing washcoat by repeatedly dunking into the coating suspension, whereupon after each dunking step the ducts of the core were blown out in order to remove an excess of suspension. After each dunking step, the core was dried in the air flow and was subsequently calcined for 15 min in the air flow at 500° C. The washcoat load was 108 g/L. Said load represents the solids content of the washcoat after calcining which was applied onto the shaped body.

The application of the compounds of the palladium, the tin and gallium onto the coated core took place in one step. For this, at first 4.3 ml of an aqueous, nitric acid-containing, 1.0 molar tin oxalate solution were mixed with 0.89 ml of an 1.0 molar gallium nitrate solution and 0.30 ml of an 1.0 molar palladium nitrate solution, and were diluted with 0.5 ml water. Subsequently, the core was dunked into the admixture of the compounds. Then, the so impregnated core was dried in the air flow and was calcined for 15 min at 500° C. in the air flow. Subsequently, the core was dried in the air flow and was calcined for 15 min at 500° C. in the air flow.

The first layer of the catalyst had 108 g/L Puralox SCFa, 20 g/L tin, 2.4 g/L gallium and 1.24 g/L palladium.

For the manufacture of the second layer of the catalyst, a zeolite (Zeocat PB/H) of the company Zeochem was suspended in deionized water and was ground in a mill (Dyno-Mill Type Multi Lab) of the company Willy A. Bachofen. The thereby produced coating suspension had a solids content of 20% by weight. To 100 ml of said suspension, 9 ml of an aqueous 0.2 molar iron nitrate solution were added and were stirred for 15 min. Subsequently, 13.2 ml of an aqueous 0.1 molar palladium nitrate solution were added and were stirred for another 15 min. For the improvement of the adhesion properties, 1.8 ml of a colloidal SiO₂ suspension (Ludox TMA, 34% SiO₂) of the company DuPont were added to the iron-, palladium-containing zeolite suspension.

Then, the core was coated with a second layer by repeatedly dunking into the ion- and palladium-containing zeolite suspension. After each dunking step, the ducts of the core were blown out in order to remove an excess of the zeolite suspension, and a drying in the air flow was carried out. Subsequently, the coating was calcined for 15 min in the air flow at 500° C. The load with the second layer was 50 g/L. Said load represents the solids content of the zeolite-containing washcoat after calcining which was applied onto the shaped body.

The second layer of the catalyst contained 50 g/L Zeocat PB/H, 0.25 g/L iron and 0.35 g/L palladium.

Subsequently, the catalyst was calcined for 2 hours at 500° C. in the muffle furnace under air (termed as “fresh”).

The completed catalyst was transferred into chips by carefully mortaring.

Three fraction of the chips were additionally calcined for 10 hours each at 950° C. and 1050° C. in air (termed as “thermally aged”).

Another fraction of the chips was calcined for 16 hours at 850° C. in air which contained 10% by volume water (termed as “hydrothermally aged”).

### Examples B11 to B12

The catalysts of the examples B11 and B12 were manufactured according to Example 10, however, instead of the dopant iron, the dopants gallium and indium were employed.

### Comparison Example 1 (CE1)

For comparison, a commercial oxidation catalyst based on platinum having a platinum content of 3.1 g/L (90 g/ft³) was employed (termed as “reference catalyst”).

The “light-off”-values of the Tables 2 and 3 as well as the FIGS. 2 and 3 show that the catalysts according to the invention have a better activity after thermally and hydrothermally aging both for the oxidation of CO and for the oxidation of HC.

Table 4 gives and overview of the sulfur concentrations which were measured in the catalysts of some of the catalysts according to the invention and of the comparison example CE01. The catalysts according to the invention take up only a low amount of sulfur and, therefore, have a clearly improved sulfur resistance.

FIG. 4 shows that the catalysts according to the invention have a clearly higher efficiency for the adsorption of octane than the platinum catalyst according to CE01. So, the catalyst according to example B10, adsorbs the octane during the first five minutes of the experiment approximately completely (graph A), whereupon the comparison catalyst CE01 takes up a maximum of half of the metered octane for only a short period (graph B).

TABLE 1
Compositions of the catalysts according to examples B01 to B12.

| | carrier oxide, zeolite, palladium, tin, promoters and dopant [g/L] | | | | | | | | | |
|---|---|---|---|---|---|---|---|---|---|---|
| | Puralox | Siralox | Zeocat | | | | | | | |
| Example | SCFa 140 | 5/170 | PB/H | Pd | Sn | Ga | In | Fe | Au | Ag |
| B01 | 96 | — | 24 | 1.65 | 19 | — | — | 0.24 | 0.01 | — |
| B02 | — | 120 | 30 | 1.8 | 7.5 | — | — | — | 0.08 | — |
| B03 | — | 120 | 30 | 1.8 | 24 | — | — | — | 0.08 | — |
| B04 | — | 90 | 40 | 2.0 | 13 | 1.3 | — | 0.65 | 0.07 | — |
| B05 | — | 90 | 40 | 2.0 | 13 | — | 1.3 | 0.65 | 0.07 | — |
| B06 | 105 | — | 45 | 1.59 | 25 | — | — | 0.11 | 0.06 | 0.75 |
| B07 | 105 | — | 45 | 0.75 | 25 | — | 1.5 | 0.11 | 0.02 | — |
| B08 | 124 | — | 50 | 1.42 | 20 | 2.4 | — | — | 0.06 | — |
| B09 | 124 | — | 25 | 1.16 | 20 | 2.4 | — | — | 0.01 | — |
| B10 | 108 | — | 50 | 1.59 | 20 | 2.4 | — | 0.25 | — | — |
| B11 | 107 | — | 50 | 1.59 | 20 | 0.25 | — | — | — | — |
| B12 | 109 | — | 50 | 1.59 | 20 | — | 0.25 | — | — | — |

TABLE 2
Results of the catalytical tests of the CO oxidation
at the catalysts after the different aging methods

| | T₅₀ (CO) [° C.] | | | |
|---|---|---|---|---|
| | | | | hydrothermally |
| | | thermally | thermally | aged at 850° C. |
| | hydrothermally | aged at | aged at | and treated |
| Example | aged at 850° C. | 950° C. | 1050° C. | with sulfur |
| B01 | 164 | 192 | 196 | 185 |
| B02 | 153 | 191 | — | 185 |
| B03 | 157 | 180 | — | 191 |
| B04 | 192 | 180 | 191 | 207 |
| B05 | — | 183 | 192 | 186 |
| B06 | 183 | 186 | 207 | 213 |
| B07 | 185 | 196 | 193 | 219 |
| B08 | 165 | 171 | 199 | 212 |
| B09 | 170 | 171 | — | 210 |
| B10 | 171 | 191 | 212 | 188 |
| B11 | 169 | 187 | — | 194 |
| B12 | 180 | 189 | — | 198 |
| CE01 | 207 | 230 | 235 | 215 |

TABLE 3
Results of the catalytical tests of the HC oxidation
at the catalysts after the different aging methods

| | T₅₀ (HC) [° C.] | | | |
|---|---|---|---|---|
| | | | | hydrothermally |
| | | thermally | thermally | aged at 850° C. |
| | hydrothermally | aged at | aged at | and treated |
| Example | aged at 850° C. | 950° C. | 1050° C. | with sulfur |
| B01 | 192 | 204 | 213 | 207 |
| B02 | 182 | 217 | — | 201 |
| B03 | 189 | 207 | — | 207 |
| B04 | 208 | 196 | 217 | 219 |
| B05 | — | 201 | 219 | 213 |
| B06 | 213 | 237 | 207 | 222 |
| B07 | 217 | 228 | 231 | 225 |
| B08 | 201 | 213 | 211 | 217 |
| B09 | 201 | 213 | — | 219 |
| B10 | 195 | 212 | 233 | 225 |
| B11 | 183 | 201 | — | 208 |
| B12 | 194 | 218 | — | 205 |
| CE01 | 220 | 237 | 260 | 228 |

TABLE 4
Results of the X-Ray Fluorenscence Analysis (XRA) of the
sulfur concentration in the catalysts after the SO₂ aging

| | | sulfur concentration |
|---|---|---|
| | condition of the catalyst prior to the | after the SO₂ aging |
| Example | SO₂ aging | [weight-%] |
| B01 | fresh | 0.9 |
| B10 | fresh | 1.3 |
| B10 | hydrothermally aged at 850° C. | 0.7 |
| B10 | thermally aged at 950° C. | 0.3 |
| CE01 | hydrothermally aged at 850° C. | 8.2 |

1.-12. (canceled)

13. A catalyst for treating exhaust gases, the catalyst comprising:
a composition of palladium, tin oxide, and a carrier oxide;
a zeolite; and
a dopant.

14. The catalyst of claim 13 wherein the palladium and the tin oxide are deposited on the carrier oxide in a roentgenographically amorphous form.

15. The catalyst of claim 13 wherein the palladium and the tin oxide are deposited on the carrier oxide in a nanoparticular form.

16. The catalyst of claim 13 wherein a first layer of carrier oxide is disposed on a shaped body and a second layer containing zeolite that is doped with the dopant is disposed on the first layer.

17. The catalyst of claim 13 wherein the carrier oxide contains an element selected from the group consisting of silicon and aluminum.

18. The catalyst of claim 13 wherein the zeolite is selected from the group consisting of Y zeolite, DAY zeolite, USY zeolite, ZSM-5, ZSM-11, ZSM-20, silicalite, ferrierite, mordenite, and β-zeolite.

19. The catalyst of claim 13 wherein the amount of dopant calculated by element is from about 0.01 to about 10 percent by weight of the amount of zeolite calculated by oxide.

20. The catalyst of claim 13 wherein the dopant is selected from the group consisting of the elements of indium, gallium, tin, iron, palladium, platinum, gold, and silver, and compounds of said elements.

21. The catalyst of claim 13 wherein the dopant is selected from the group consisting of rare earth elements and compounds of said elements.

22. The catalyst of claim 13 wherein the composition further comprises a promoter.

23. The composition of claim 22 wherein the promoter is selected from the group consisting of the elements of indium, gallium, iron, platinum, gold, and silver, and compounds of said elements.

24. The composition of claim 22 wherein the promoter is selected from the group consisting of alkali metals, earth alkali metals, and compounds of such metals.

25. The composition of claim 22 wherein the promoter is selected from the group consisting of rare earth elements and compounds of said elements.
